(19) United States
(12) Patent Application Publication
(10) Pub. No.: US 2025/0373764 A1
(43) Pub. Date: Dec. 4, 2025

(54) PICTURE STABILIZER FOR AIRCRAFT INTERIOR DISPLAY

(71) Applicant: GOODRICH LIGHTING SYSTEMS, INC., Phoenix, AZ (US)

(72) Inventors: Longke Wang, Glastonbury, CT (US); Caroline Reilly, Chapel Hill, NC (US)

(73) Assignee: GOODRICH LIGHTING SYSTEMS, INC., Phoenix, AZ (US)

(21) Appl. No.: 18/679,112

(22) Filed: May 30, 2024

(51) Int. Cl. H04N 9/31; B64D 11/00

(52) U.S. Cl. CPC H04N 9/3185; B64D 11/00151; H04N 9/3194

(57) ABSTRACT

A system for picture stabilization is disclosed herein. The system includes a blur detection mechanism configured to perform image analysis to identify a differential displacement of a displayed image on a display surface. The system includes an image steering mechanism configured to adjust a projection of a next displayed image in accordance with the differential displacement.

### FIELD

The present disclosure generally relates to systems for displaying images in an aircraft, and more specifically, to picture stabilization for an aircraft interior display.

### BACKGROUND

Aircraft interiors, such as walls, ceilings, floors, etc. may be used as display surfaces for various purposes. However, vibrations from aircraft body excite dynamics of the display surfaces and projector. Such vibrations may become visible because of image projections, which may provide an unpleasant experience or provide incorrect information to passengers within the aircraft.

### SUMMARY

A system for picture stabilization is disclosed herein. The system includes a blur detection mechanism and an image steering mechanism. The blur detection mechanism is configured to perform image analysis to identify a differential displacement of a displayed image on a display surface. The image steering mechanism is configured to adjust a projection of a next displayed image in accordance with the differential displacement.

In various embodiments, blur detection mechanism determines the differential displacement utilizing an image indicating a fixed-point position, an image indicating a current image position, a previous image indicating the fixed-point position, and a previous image indicating a previous image position.

In various embodiments, the system further includes a projector. In various embodiments, the image indicating the fixed-point position and the image indicating the current image position are captured by a camera adjacent to the projector.

In various embodiments, the system further includes a passenger seat. In various embodiments, the image indicating the fixed-point position and the image indicating the current image position are captured by a camera adjacent to the passenger seat.

In various embodiments, the system further includes a projector. In various embodiments, the adjustment of the projection of the next displayed image adjusts a projection of the next displayed image within a display memory area.

In various embodiments, the adjustment of the projection of the next displayed image adjusts the next displayed image in at least one of a first direction or a second direction and wherein the second direction is perpendicular to the first direction.

In various embodiments, the adjustment of the projection of the next displayed image adjusts the next displayed image in a first direction and a second direction and wherein the second direction is perpendicular to the first direction.

In various embodiments, the display surface is at least one of a front wall, a rear wall, a side wall, a floor, or a ceiling of an aircraft.

In various embodiments, the system further includes a fixed point. In various embodiments, the adjustment of the projection of the next displayed image adjusts the next displayed image with regard to the fixed point. In various embodiments, the fixed point is on or adjacent to the display surface. In various embodiments, the fixed point is at least one of an airline logo, a window, an installation fixture, or an identifiable mark.

In various embodiments, the system further includes a projector and a passenger seat. In various embodiments, at least one of the projector, the display surface, or the passenger seat are coupled to a structure of an aircraft via a damping mechanism.

Also disclosed herein is a control system for picture stabilization. The control system includes a projector, an image steering mechanism; and a tangible, non-transitory memory. The projection is configured to display an image on a display surface. The tangible, non-transitory memory is configured to communicate with the image steering mechanism, the tangible, non-transitory memory having instructions stored thereon that, in response to execution by the image steering mechanism, cause the image steering mechanism to perform operations including performing image analysis to identify a differential displacement of the image and adjusting a projection of a next image in accordance with the differential displacement.

In various embodiments, the instructions, when executed by the image steering mechanism, further cause the image steering mechanism to: determine the differential displacement utilizing an image indicating a fixed-point position, an image indicating a current image position, a previous image indicating the fixed-point position, and a previous image indicating a previous image position.

In various embodiments, the image indicating the fixed-point position and the image indicating the current image position are captured by a camera adjacent to at least one of the projector or a passenger seat.

In various embodiments, the adjustment of the projection of the next image adjusts a projection of the next displayed image within a display memory area.

In various embodiments, the adjustment of the projection of the next image adjusts the next image in at least one of a first direction or a second direction. In various embodiments, the second direction is perpendicular to the first direction.

In various embodiments, the adjustment of the projection of the next image adjusts the next image in a first direction and a second direction. In various embodiments, the second direction is perpendicular to the first direction.

In various embodiments, the adjustment of the projection of the next image adjusts the next image with regard to a fixed point. In various embodiments, the fixed point is on or adjacent to the display surface. In various embodiments, the fixed point is at least one of an airline logo, a window, an installation fixture, or an identifiable mark.

Also disclosed herein is a method for picture stabilization. The method includes performing image analysis to identify a differential displacement of an image displayed on a display surface and adjusting a projection of a next image in accordance with the differential displacement.

In various embodiments, the method further includes determining the differential displacement utilizing an image indicating a fixed-point position, an image indicating a current image position, a previous image indicating the fixed-point position, and a previous image indicating a previous image position.

In various embodiments, the image indicating the fixed-point position and the image indicating the current image position are captured by a camera adjacent to at least one of a projector or a passenger seat.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft and various sections within the aircraft, in accordance with various embodiments.

FIG. 2 illustrates an implementation of a picture stabilizer system, in accordance with various embodiments.

FIG. 3 illustrates components of an image steering mechanism for a picture stabilizer system, in accordance with various embodiments.

FIG. 4 illustrates an exemplary process of image steering, in accordance with various embodiments.

FIG. 5 illustrates a method for picture stabilization, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As stated previously, aircraft interiors, such as walls, ceilings, floors, etc. may be used as display surfaces for various purposes. However, vibrations from aircraft body excite dynamics of the display surfaces and projector. Such vibrations may become visible because of image projections, which may provide an unpleasant experience or provide incorrect information to passengers within the aircraft.

Disclosed herein is a picture stabilizer system for an aircraft interior display by which videos or pictures are projected onto surfaces within the aircraft. In various embodiments, rather than being rigidly affixed to a structure of the aircraft, a projector, a display surface, and/or a seat may be coupled to the structure of the aircraft via a sets of damping mechanisms. In various embodiments, by coupling the projector, the display surface, and/or the passenger's seat to the structure of the aircraft via the sets of damping mechanisms, both linear and angular displacement with respect to the frame of aircraft is provided responsive to vibrations of the aircraft. In that regard, in various embodiments, responsive to the structure of the aircraft vibrating, rather than images projected onto a display surface being displaced because both projector and the display surface shaking, the picture stabilizer system actively steers the projection of the image in at an angle Δƒ to compensate for undesired image displacement ΔP because of the vibration of the aircraft. In various embodiments, both the angle Δƒ and the image displacement ΔP are in two dimensions. In various embodiments, the image displacement ΔP may be determined from the projectors point of view with reference to the display surface. In various embodiments, the image displacement ΔP may be determined from the passenger's seat point of view with reference to the display surface.

In various embodiments, the image displacement ΔP without the picture stabilizer system may cause projected images to blur, thereby distorting the projected image. In various embodiments, an amount of distorting may be referred to as a phase error. In various embodiments, the picture stabilizer system utilizes blur detection to determine the phase error and, on predicting a next phase error, the picture stabilizer system steers a frame of the image a determined amount of angle Δƒ to substantially cancel out the phase error. In various embodiments, the terms “substantially,” “about,” or “approximately” as used herein represent an amount close to the stated amount that still performs a desired function or achieves a desired result. For example, the term “substantially,” “about” or “approximately” may refer to an amount that is within 5% of a stated amount or value. In various embodiments, the picture stabilizer system operates in a closed loop at the flashing rate of images, for example, 24 Hertz, 30 Hertz, or 60 Hertz, among others.

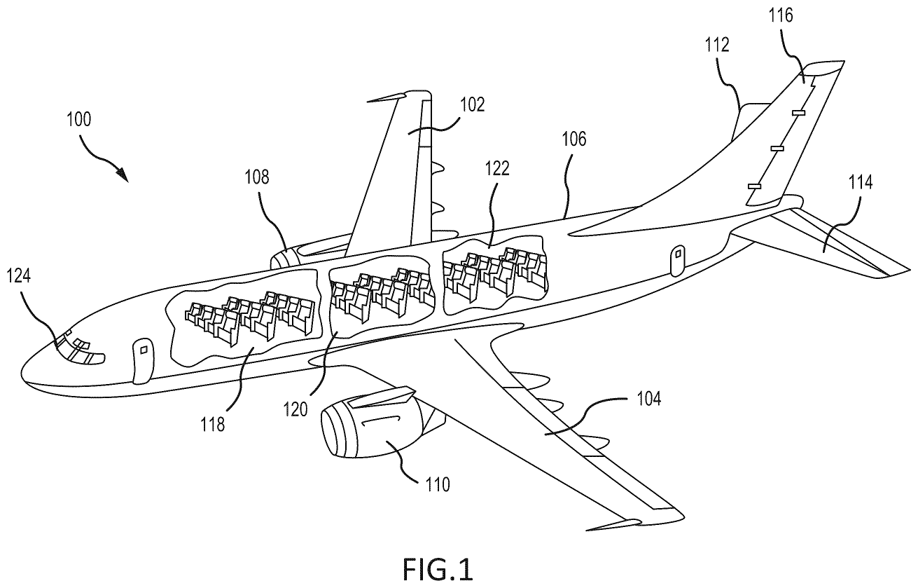

Referring now to FIG. 1, an aircraft 100 and various sections within the aircraft is illustrated, in accordance with various embodiments. Aircraft 100 is an example of a passenger or transport vehicle in which a cooling system may be implemented in accordance with various embodiments. In various embodiments, aircraft 100 has a starboard wing 102 and a port wing 104 attached to a fuselage 106. In various embodiments, aircraft 100 also includes a starboard engine 108 connected to starboard wing 102 and a port engine 110 connected to port wing 104. In various embodiments, aircraft 100 also includes a starboard horizontal stabilizer 112, a port horizontal stabilizer 114, and a vertical stabilizer 116. In various embodiments, aircraft 100 also includes various cabin sections, including, for example, a first cabin section 118, a second cabin section 120, a third cabin section 122, and a pilot cabin 124.

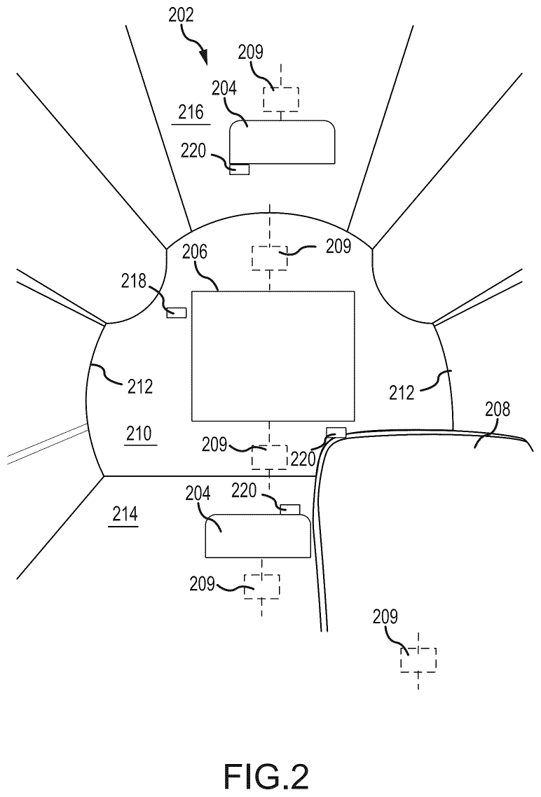

Referring now to FIG. 2, in accordance with various embodiments, an implementation of picture stabilizer system is illustrated. In particular, the picture stabilizer system 200 may be implemented in a cabin compartment 202, such as the first cabin section 118, the second cabin section 120, or the third cabin section 122 of the aircraft 100 of FIG. 1. In various embodiments, the illustrated view may be looking toward a forward or front portion of the inside of the cabin compartment 202. In various embodiments, the illustrated view may be looking toward a rear portion of the inside of the cabin compartment 202. In various embodiment, the picture stabilizer system 200 may include a projector 204, a display surface 206, and a passenger seat 208. In various embodiments, the projector 204, the display surface 206, and the passenger seat 208 may be coupled to a structure of the aircraft via a respective damping system 209. In various embodiments, the damping system may be a spring damping system, a pad damping system, or a hydraulic damping system, among others. In various embodiments, the display surface 206 may be a front or rear wall 210, a sidewall 212, a floor 214, or a ceiling 216. In various embodiments, the projector 204 may be located near or adjacent to the floor 214. In various embodiments, the projector 204 may be located near or adjacent to the ceiling 216.

In various embodiments, as an aircraft taxis, takes off, flies, or lands, disturbances, such as those caused by taxiways, runways, and turbulent conditions, such as gravity waves, convection, or clear air turbulence, among others, may cause the body of the aircraft to vibrate, which excites dynamics of the projector 204, the display surface 206, and the passenger seat 208 and creates differential displacements between the image projected by the projector 204 and the position where the image is displayed on the display surface 206, i.e. and undesired image displacement ΔP. In that regard, the image displacement ΔP resulting from the mixed dynamics from the projector 204, the display surface 206, and the passenger seat 208 causes, the projected image to blur and/or distort the projected image, which is a phase error, that the picture stabilizer system 200 of the illustrative embodiments corrects. In various embodiments, the picture stabilizer system 200 utilizes a fixed point 218 on or adjacent to the display surface 206 to identify the differential displacement of the displayed image on the display surface 206. In various embodiments, the fixed point 218 may be an airline logo, a window, an installation fixture, or an identifiable mark, among others. In various embodiments, the fixed point 218 and a position of the displayed image by be detected using a camera 220 adjacent to the projector 204 or the passenger seat 208.

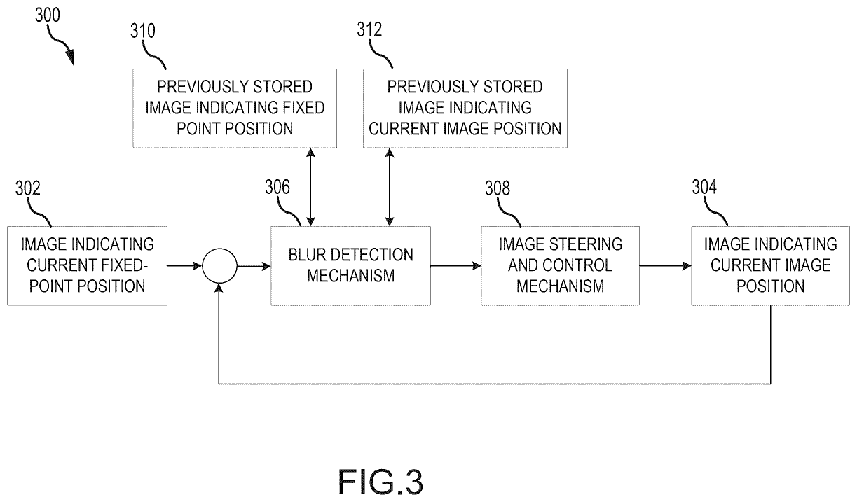

Referring now to FIG. 3, in accordance with various embodiments, components of an image steering mechanism, i.e. a control system, for a picture stabilizer system, such as picture stabilizer system 200 of FIG. 2, is illustrated. In various embodiments, the image steering mechanism 300 includes an image indicating current fixed-point position 302, an image indicating current image position 304, blur detection mechanism 306, and image steering and control mechanism 308. In various embodiments, the blur detection mechanism 306 receives the image indicating current fixed-point position 302 from a camera, such as camera 220 of FIG. 2, that includes a current position of the fixed point, such as fixed point 218 of FIG. 2. In various embodiments, the blur detection mechanism 306 also receives the image indicating current image position 304 from the camera that includes a position of the currently displayed image. In various embodiments, the image indicating the current fixed-point position 302 and the image indicating current image position 304 may be a same image. In various embodiments, the image indicating a current fixed-point position 302 and the image indicating a current image position 304 may be different images. In various embodiments, utilizing a previously stored image indicating the fixed-point position 310 and a previously stored image indicating previous image position 312, the blur detection mechanism 306 performs image analysis to identify a differential displacement of the displayed image on the display surface. In various embodiments, the previously stored image indicating the fixed-point position 310 and the previously stored image indicating the previous image position 312 may be a same image. In various embodiments, the previously stored image indicating the fixed-point position 310 and the previously stored image indicating the previous image position 312 may be different images. In various embodiments, the differential displacement may have one or more of a x-component, i.e. a side-to-side component or a first direction, and a y-component, i.e. an up and down component or a second direction, with respect to the display surface. It is noted that, in various embodiments, if there is no previously stored image indicating the fixed-point position 310 or a previously stored image indicating the previous image position 312, the blur detection mechanism 306 may indicating that image steering is not required for next frame.

In various embodiments, responsive to the blur detection mechanism 306 determining a differential displacement, the blur detection mechanism 306 sends the differential displacement to the image steering and control mechanism 308. In various embodiments, the image steering and control mechanism 308 is coupled to a projector, such as projector 204 of FIG. 2. In various embodiments, responsive to receiving the differential displacement, the image steering and control mechanism 308 adjusts a projection of the image within a display memory area, as described hereafter. That is, in various embodiments, the image steering and control mechanism 308 implements image shifting so as to move the displayed image from one location to another location by some displacement, as provided by the differential displacement, to compensate for potential distortions. In that regard, in various embodiments, the image steering and control mechanism 308 implements one or more of a direct feedback control that directs error compensation using feedback and simple models, zero-phase error tracking that utilizes a model to regulate phase error, a zero-phase error tracking with repetitive controller that utilizes a model and a repetitive controller as a control core to regulate phase error, a zero-phase error tracking with repetitive controller and with off-line model identification that utilizes a periodical model identification process and a repetitive controller as a control core to regulate phase error, or an adaptive zero-phase error tracking with repetitive controller that utilizes an adaptive identification process and a repetitive controller as a control core to regulate phase error. In various embodiments, the blur detection mechanism 306 is designed for real-time detection of the differential displacement in a closed loop. That is, after each differential displacement is identified and provided to the image steering and control mechanism 308, the previously stored image indicating the fixed-point position 310 and the previously stored image indicating the previous image position 312 are replaced with the image indicating current fixed-point position 302 and the image indicating current image position 304, respectively, for used in a next differential displacement determination by the blur detection mechanism 306. In various embodiments, the displacement determination by the blur detection mechanism 306 may occur at any flash rate, such as 24 Hertz, 30 Hertz, or 60 Hertz, among others.

In various embodiments, the blur detection mechanism 306 and the image steering and control mechanism 308 may be a single component. In various embodiments, the blur detection mechanism 306 and the image steering and control mechanism 308 may be separate components. In various embodiments, the blur detection mechanism 306 and the image steering and control mechanism 308 may include a logic device such as one or more of a central processing unit (CPU), an accelerated processing unit (APU), a digital signal processor (DSP), a field programmable gate array (FPGA), an application specific integrated circuit (ASIC), or the like. In various embodiments, the blur detection mechanism 306 and the image steering and control mechanism 308 may further include any non-transitory memory known in the art. The memory may store instructions usable by the logic device to perform operations as described herein.

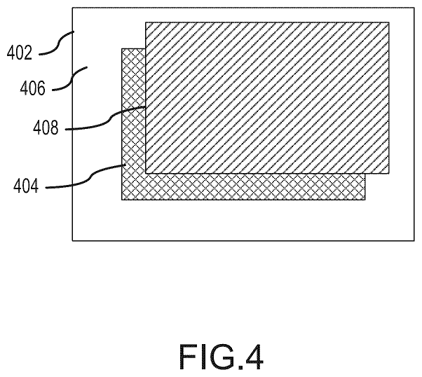

Referring now to FIG. 4, in accordance with various embodiments, an exemplary process of image steering is illustrated. In various embodiments, the image steering may be performed by image processing and image-shifting within a display memory area 402 of a projector, such as projector 204 of FIG. 2. In various embodiments, in a default state. i.e. where no image steering is needed, an image 404 to be displayed will be directly written to a center region of the display memory area 402 that corresponds a full frame of a display. In various embodiments, a “backlight off” zone 406 includes margins that lie between the image 404 to be shown and a boundary of the display memory area 402. In various embodiments, pixels in the “backlight off” zone 406 either are not lighted (backlight off) or are projected to a color that is similar to the display surface. In various embodiments, a size of the margin may be a dimension of how far an image can be freely shifted. In various embodiments, responsive to receiving a steering command, the “centered” image 406 may be shifted to a newly determined display memory location, i.e. steered image 408, and the remaining pixels filled into the “backlight off” zone 406. It is worth noting that image shifting is not necessary as a 1-to-1 copy. In that regard, in various embodiments, image processing may involve pre-distorting an original image to cancel out possible image distortion, due to, for example, a curvature of the display surface at the commanded location.

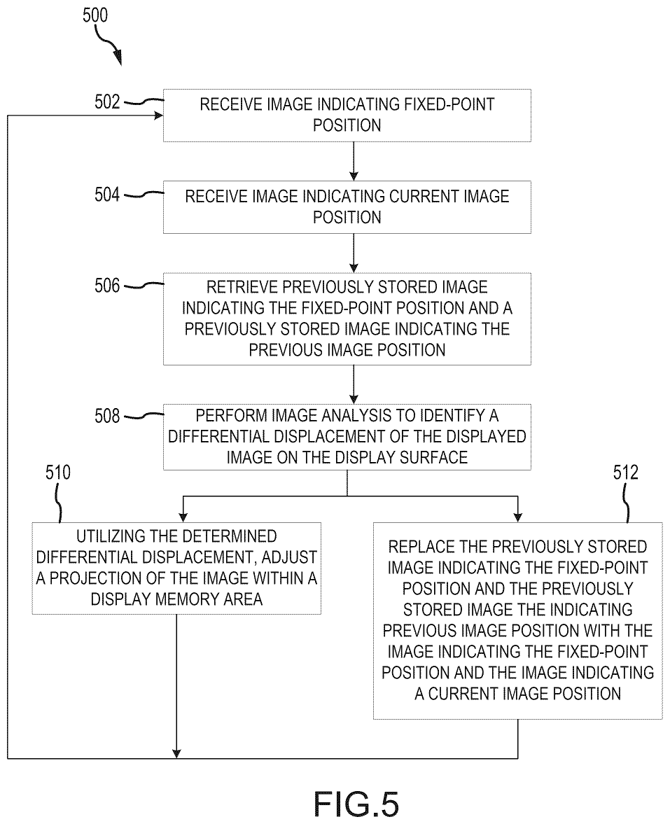

Referring now to FIG. 5, in accordance with various embodiments, a method 500 for picture stabilization is illustrated. The method 500 may be performed by an image steering mechanism 300 described above with respect to FIG. 3. At block 502, the image steering mechanism receives an image indicating a fixed-point position. At block 504, the image steering mechanism receives an image indicating a current image position. At block 506, the image steering mechanism retrieves a previously stored image indicating the fixed-point position and a previously stored image indicating a previous image position. At block 508, the image steering mechanism performs image analysis to identify a differential displacement of the displayed image on the display surface. At block 510, the image steering mechanism utilizes the determined differential displacement to adjust a projection of the image within a display memory area, as described above. At substantially a same time, at block 512, the image steering mechanism replaces the previously stored image indicating the fixed-point position and the previously stored image the indicating previous image position with the image indicating the fixed-point position and the image indicating a current image position, which become the previously stored image indicating the fixed-point position and the previously stored image indicating a previous image position. From blocks 510 and 512, the process returns to block 502.

Accordingly, aircraft interiors are used as display boards for various purposes. However, vibrations may cause blurred or distorted images that create undesired passenger experiences. Therefore, the carious illustrative embodiments, reduce or eliminate image blurring in order to improve passenger visual experience.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system for picture stabilization, the system comprising:
a blur detection mechanism configured to perform image analysis to identify a differential displacement of a displayed image on a display surface; and
an image steering mechanism configured to adjust a projection of a next displayed image in accordance with the differential displacement.

2. The system of claim 1, wherein the blur detection mechanism determines the differential displacement utilizing an image indicating a fixed-point position, an image indicating a current image position, a previous image indicating the fixed-point position, and a previous image indicating a previous image position.

3. The system of claim 2, further comprising:
a projector, wherein the image indicating the fixed-point position and the image indicating the current image position are captured by a camera adjacent to the projector.

4. The system of claim 2, further comprising:
a passenger seat, wherein the image indicating the fixed-point position and the image indicating the current image position are captured by a camera adjacent to the passenger seat.

5. The system of claim 1, further comprising:
a projector, wherein the adjustment of the projection of the next displayed image adjusts a projection of the next displayed image within a display memory area.

6. The system of claim 1, wherein the adjustment of the projection of the next displayed image adjusts the next displayed image in at least one of a first direction or a second direction and wherein the second direction is perpendicular to the first direction.

7. The system of claim 1, wherein the adjustment of the projection of the next displayed image adjusts the next displayed image in a first direction and a second direction and wherein the second direction is perpendicular to the first direction.

8. The system of claim 1, wherein the display surface is at least one of a front wall, a rear wall, a side wall, a floor, or a ceiling of an aircraft.

9. The system of claim 2, further comprising:
a fixed point, wherein the adjustment of the projection of the next displayed image adjusts the next displayed image with regard to the fixed point, wherein the fixed point is on or adjacent to the display surface, and wherein the fixed point is at least one of an airline logo, a window, an installation fixture, or an identifiable mark.

10. The system of claim 1, further comprising:
a projector; and
a passenger seat,
wherein at least one of the projector, the display surface, or the passenger seat are coupled to a structure of an aircraft via a damping mechanism.

11. A control system for picture stabilization, the control system comprising:
a projector configured to display an image on a display surface;
an image steering mechanism; and
a tangible, non-transitory memory configured to communicate with the image steering mechanism, the tangible, non-transitory memory having instructions stored thereon that, in response to execution by the image steering mechanism, cause the image steering mechanism to perform operations comprising:
performing image analysis to identify a differential displacement of the image; and
adjusting a projection of a next image in accordance with the differential displacement.

12. The control system of claim 11, wherein the instructions, when executed by the image steering mechanism, further cause the image steering mechanism to:
determine the differential displacement utilizing an image indicating a fixed-point position, an image indicating a current image position, a previous image indicating the fixed-point position, and a previous image indicating a previous image position.

13. The control system of claim 12, wherein the image indicating the fixed-point position and the image indicating the current image position are captured by a camera adjacent to at least one of the projector or a passenger seat.

14. The control system of claim 11, wherein the adjustment of the projection of the next image adjusts a projection of the next displayed image within a display memory area.

15. The control system of claim 11, wherein the adjustment of the projection of the next image adjusts the next image in at least one of a first direction or a second direction and wherein the second direction is perpendicular to the first direction.

16. The control system of claim 11, wherein the adjustment of the projection of the next image adjusts the next image in a first direction and a second direction and wherein the second direction is perpendicular to the first direction.

17. The control system of claim 12, wherein the adjustment of the projection of the next image adjusts the next image with regard to a fixed point, wherein the fixed point is on or adjacent to the display surface, and wherein the fixed point is at least one of an airline logo, a window, an installation fixture, or an identifiable mark.

18. A method for picture stabilization, the method comprising:
performing image analysis to identify a differential displacement of an image displayed on a display surface; and
adjusting a projection of a next image in accordance with the differential displacement.

19. The method of claim 18, further comprising:
determining the differential displacement utilizing an image indicating a fixed-point position, an image indicating a current image position, a previous image indicating the fixed-point position, and a previous image indicating a previous image position.

20. The method of claim 19, wherein the image indicating the fixed-point position and the image indicating the current image position are captured by a camera adjacent to at least one of a projector or a passenger seat.
